(19) United States
(12) Patent Application Publication
(10) Pub. No.: US 2011/0280371 A1
(43) Pub. Date: Nov. 17, 2011

(54) TiO2 Nanotube Cathode for X-Ray Generation

(76) Inventors: Sabee Molloi, Laguna Beach, CA (US); Yahya Alivov, Irvine, CA (US)

(21) Appl. No.: 13/106,394

(22) Filed: May 12, 2011

Related U.S. Application Data
(60) Provisional application No. 61/333,878, filed on May 12, 2010.

(51) Int. Cl. G01N 23/04; H01J 35/06; B82Y 99/00; B82Y 30/00

(52) U.S. Cl. 378/62; 378/136; 977/742; 977/950

(57) ABSTRACT

A device is provided for the generation of x-ray emission from an x-ray source based on titanium dioxide (TiO₂) nanotubes grown by electrochemical oxidation. TiO₂ nanotubes are used as a cold cathode in x-ray tubes.

### CROSS-REFERENCE TO RELATED APPLICATIONS

This application claims the benefit of provisional application Ser. No. 61/333,878, filed May 12, 2010, which is fully incorporated herein by reference.

### FIELD

The embodiments provided herein relate generally to medical x-ray imaging, and more particularly to a device for the generation of x-ray emission using titanium dioxide (TiO₂) nanotubes.

### BACKGROUND INFORMATION

Carbon nanotubes (CNTs) are an acceptable nanoscale field emission electron source and have been used as a cold cathode in x-ray tubes. CNTs and carbon nanofibers (CNFs) have been widely explored for their small tip radius of curvature, high aspect ratio, and mechanical toughness. However, a significant challenge for CNT-based x-ray tubes is the problem of degradation, which leads to lower longevity. There are two main reasons for the degradation in CNT-based x-ray tubes: first, oxidation of the CNTs due to the reaction of the CNTs with the residual oxygen always present in a vacuum chamber, even at 10⁻⁹-10⁻¹⁰ Torr, which is sufficient to oxidize CNTs; and second, there exists a poor adhesion of CNTs to conductive substrates, resulting in poor electrical contact that leads to increased resistivity of the interface layer, and therefore, to heating effects.

To overcome the degradation problem of CNTs as cold cathodes in x-ray tubes, an improved cathode is desirable.

### SUMMARY

The embodiments provided herein are directed to a device for the generation of x-ray using titanium dioxide nanotube (TiO₂ NT) arrays as a cold cathode capable of generating x-ray emission.

Electrochemically grown TiO₂ NTs are a material that can overcome the drawbacks associated with CNTs. First, being a natural oxide, TiO₂ NTs are not affected by oxygen, so exposure to oxygen is not of any danger to the properties of TiO₂ NTs. Second, regarding electrical contact, TiO₂ NTs during electrochemical anodization are grown directly on the titanium (Ti) sheets and as the latter oxidizes, a good electrical contact between the TiO₂ NT film and conductive Ti sheet is intrinsically guaranteed. As a result, x-ray generation systems based on TiO₂ NTs as a cold cathode have greatly enhanced lifetimes.

In one embodiment, x-ray generation system comprises a TiO₂ NT cathode, an anode, a grid electrode, and a detector. Preferably, the TiO₂ NT cathode comprises TiO₂ NT arrays grown on a substrate by electrochemical oxidation. In a preferred embodiment the substrate comprises a Titanium (Ti) sheet.

In one embodiment, the TiO₂ NT arrays may have diameters of 80 nm and heights of 5 μm, where the TiO₂ NT arrays are grown on a Ti substrate sheet with a 0.25 mm thickness and 99.97% purity via electrochemical oxidation in a glycerol+HF electrolyte and an applied anodization voltage at 30 V for 12 hours. In another embodiment, TiO₂ NT arrays are grown from a Ti substrate by electrochemical oxidation in electrolyte, prepared using NH₄F (98%) and ethylene glycol (99.8%). It is appreciated that electrochemical anodization can be carried out in an applied anodization DC voltage range of 30-60 V with an NH₄F concentration varying in a range of 0.1-2 wt %. In another embodiment, water (H₂O 10%) can be added to the electrolyte to increase the growth rate of the TiO₂ NT arrays.

The diameters of TiO₂ NT arrays may range from 20-550 nm and the heights of TiO₂ NT arrays may range from 0.5-12 μm. The emission density and the field enhancement factor of the TiO₂ NT cathode are influenced by certain parameters of TiO₂ NT arrays, such as diameter and height.

In one embodiment, the as-grown amorphous TiO₂ NT arrays are annealed at 500° C. in ambient atmosphere for one hour, which converts the TiO₂ NT arrays to anatase crystal phase. Annealed 5×5 mm² sized samples of the TiO₂ NT arrays are then bonded to an aluminum backplane with silver-based electron microscopy adhesion solution.

In one embodiment, the anode is a 2 mm diameter copper rod; the grid electrode is a weave of 30 μm diameter copper wire mesh; and the detector is a Varian PaxScan 4030CB CsI charge integrating detector. The anode can be situated 10 mm in front of the grid electrode. In one embodiment, a 400 μm glass spacer is placed between the TiO₂ NT cathode and the grid electrode and a 0.33 cm² area of the TiO₂ NT arrays is exposed to the grid electrode. X-ray generation system may also comprise a stainless steel vacuum chamber with alumina electrical feedthroughs. In one embodiment, a borosilicate glass window is placed at a right angle to the anode and the TiO₂ NT cathode to allow x-ray emission to exit the chamber.

In operation of the x-ray generation system, the TiO₂ NT cathode is capable of emitting field emitted electrons, which are used to produce x-ray emission. In one embodiment, x-ray generation system is held at a dynamic vacuum of 5×10⁻⁷ Torr in a stainless steel vacuum chamber and the system generates x-ray emission by applying a field emission current of 450 μA. In operation, the applied current to the grid electrode pulls electrons out of the TiO₂ NT cathode. The electrons then pass through the copper wire mesh holes of the grid electrode and strike the anode. In one embodiment, a 60 kV voltage is applied to the anode, which accelerates the electrons to produce x-ray emission.

An x-ray generation system comprising a TiO₂ NT cathode source is capable of producing a radiograph image of a standard 1 mm Pb thick resolution phantom with an integration time of 1 second, where a resolution phantom is positioned at the face of the detector of the x-ray generation system.

The diameters of TiO₂ NT arrays can be varied by adjusting the applied electrochemical anodization DC voltage and the heights of TiO₂ NT arrays can be varied by adjusting the electrochemical growth time.

It is appreciated that TiO₂ field emitters can be used not only in x-ray tubes, but also in other devices, such as solar cells, flat panels, microwave generators, etc.

Other systems, methods, features, and advantages of the example embodiments will be or will become apparent to one with skill in the art upon examination of the following figures and detailed description.

### BRIEF DESCRIPTION OF THE FIGURES

The details of the embodiments, including fabrication, structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 depicts a schematic illustration of an x-ray generation system comprising titanium dioxide (TiO₂) nanotube (NT) arrays as a cold cathode of the x-ray system.

FIG. 2 depicts a schematic illustration of a cold cathode comprising TiO₂ NT arrays grown on a substrate.

FIG. 3(a) illustrates a radiograph image of a standard 1 mm Pb thick resolution phantom, which is produced from a TiO₂ NT cold cathode source. FIG. 3(b) illustrates an image produced by a conventional medical x-ray tube (Dynamax 79-45/120, Machlett Laboratories) with a 1.2 mm focal spot.

FIGS. 4(a)-(f) illustrate scanning electron microscope (SEM) images of TiO₂ NT arrays with varying average NT diameters. FIG. 4(a) illustrates an SEM image of TiO₂ NT arrays with diameters of 20 nm; FIG. 4(b) illustrates an SEM image of TiO₂ NT arrays with diameters of 40 nm; FIG. 4(c) illustrates an SEM image of TiO₂ NT arrays with diameters of 80 nm; FIG. 4(d) illustrates an SEM image of TiO₂ NT arrays with diameters of 170 nm;

FIG. 4(e) illustrates an SEM image of TiO₂ NT arrays with diameters of 320 nm; and FIG. 4(f) illustrates an SEM image of TiO₂ NT arrays with diameters of 550 nm.

FIG. 5 illustrates a schematic diagram of an exemplary embodiment of an experimental setup for field emission measurements of a cold cathode comprising TiO₂ NT arrays.

FIG. 6 illustrates field emission current-voltage (I-V) characteristics of TiO₂ NT arrays having varying diameters.

FIG. 7 illustrates a Fowler-Nordheim (F-N) plot depicting a nearly linear relationship between ln(J/E²) and 1/E of TiO₂ NT arrays having varying diameters.

FIG. 8 illustrates a summarized plot of field emission current density and field enhancement factor measurements for TiO₂ NT arrays having varying diameters, where the heights of the TiO₂ NT arrays were kept constant at ˜2 μm.

FIG. 9 illustrates field emission current-voltage (I-V) characteristics of TiO₂ NT arrays having an average diameter of 100 nm.

FIG. 10 illustrates a Fowler-Nordheim (F-N) plot where the linear relationship between ln(J/E²) and 1/E shows the field emission nature of TiO₂ NT arrays having an average diameter of 100 nm.

FIG. 11 illustrates a graph of the emission current stability of TiO₂ NT arrays having an average diameter of 100 nm as a function of time.

FIG. 12 illustrates a graph over an extended time scale of the emission current stability of TiO₂ NT arrays having an average diameter of 100 nm as a function of time.

FIG. 13 illustrates a summarized plot of field emission density and field enhancement factor measurements for TiO₂ NT arrays having varying NT heights, where the diameters of the TiO₂ NT arrays were kept constant at ˜320 nm.

FIG. 14 illustrates an energy band diagram for a TiO₂ semiconductor in electric field.

FIG. 15 illustrates a graph depicting the theoretical effects of the diameter and wall thickness of an isolated TiO₂ NT on its field enhancement factor.

FIG. 16 illustrates a graph depicting the theoretical effects of the height and diameter of an isolated TiO₂ NT on its field enhancement factor.

FIG. 17 illustrates a graph depicting the dependence of the field enhancement factor on the intertube spacing of TiO₂ NT arrays.

FIG. 18 illustrates a plot of the normalized current density of TiO₂ NT arrays as a function of intertube spacing.

### DETAILED DESCRIPTION

The embodiments provided herein are directed to a field emission cold cathode electron source for generating x-ray radiation based on titanium dioxide nanotubes (TiO₂ NTs).

Recently, nanoscale field emission electron sources, such as nanotubes (NTs), nanorods, and nanofibers, have attracted a considerable degree of interest due to their applications in x-ray tubes. Carbon NTs (CNTs) and carbon nanofibers (CNFs) have been widely explored due to their small tip radius of curvature, high aspect ratio, and mechanical toughness. Despite their advantages and the studies and progress made in this area, the use of CNTs as a cold cathode in x-ray tubes are still far from being of practical use. One of the main reasons for their failure is that CNTs suffer from fast degradation that leads to lower longevity. This occurs primarily for the following two reasons: first, CNTs experience oxidation in a vacuum chamber because residual oxygen is always present in vacuum chamber even at 10⁻⁹-10⁻¹⁰ Torr, which is sufficient enough to oxidize CNTs; and second, CNTs experience poor adhesion to conductive substrates, which results in enhanced electrical resistivity of the interface layer, thus, leading to heating effects.

Electrochemically grown TiO₂ NTs seem to be an excellent choice to overcome these problems. First, since TiO₂ is a natural oxide, it is not affected by oxygen so its exposure to oxygen will not affect its properties; likewise, no special measures need to be taken to prevent its reaction with air. Second, as explained in greater detail below, TiO₂ NTs can be grown on titanium (Ti) sheets, and as the latter oxidizes during anodization, a good electrical contact between TiO₂ NT film and conductive Ti sheet is intrinsically guaranteed. The electrochemical growth process is also very simple and it does not require expensive tools for TiO₂ NT growth. The employment of this type of TiO₂NTs should further decrease the cost of cold cathodes. TiO₂ NTs also have a lower work function range (3.9-4.5 eV) compared to CNTs (˜5.0 eV). Furthermore, TiO₂ NT experiences a higher degree of NT array uniformity, which ensures a narrower electron kinetic energy distribution; and, therefore, a better spatial resolution due to more uniform field emission conditions. The latter significantly contrasts with CNTs, which grow in different diameters, helicity, and orientation on the same growth run. Oxide materials have also been proven to be very radiation tolerant.

A principle purpose of the embodiments described herein is the use of TiO₂ NTs as a viable and suitable field emission electron source capable of generating x-ray emission.

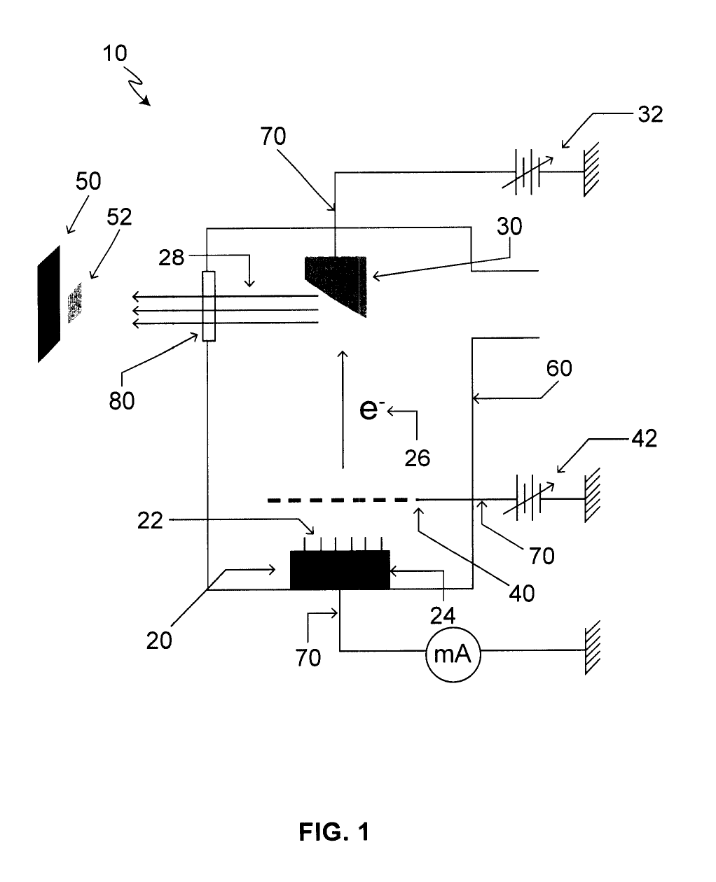

FIG. 1 depicts a schematic illustration of x-ray generation system 10 comprising a titanium dioxide nanotube (TiO₂ NT) cathode 20, an anode 30, a grid electrode 40, and a detector 50.

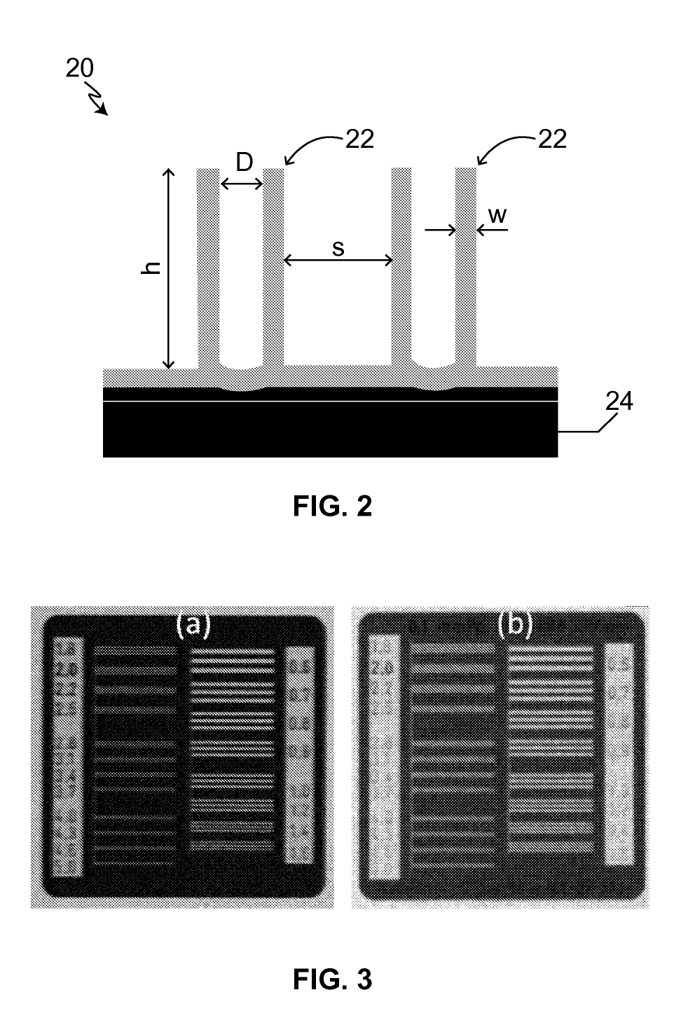

In a preferred embodiment of x-ray generation system 10, TiO₂ NT cathode 20 comprises TiO₂ NT arrays 22 grown on substrate 24 by electrochemical oxidation. FIG. 2 depicts a schematic illustration of TiO₂ NT cathode 20 comprising TiO₂ NT arrays 22 grown on substrate 24, where TiO₂ NT arrays 22 have a diameter D and a height h. In a preferred embodiment substrate 24 comprises a Titanium (Ti) sheet.

In one embodiment, TiO₂ NT arrays 22 with diameters D of 80 nm and heights h of 5 μm are grown on substrate 24 comprising a Ti sheet with a 0.25 mm thickness and 99.97% purity via electrochemical oxidation in a glycerol+HF electrolyte with an applied anodization voltage of 30 V for 12 hours. In another embodiment, TiO₂ NT arrays 22 are grown from substrate 24 by electrochemical oxidation in electrolyte, prepared using NH₄F (98%) and ethylene glycol (99.8%). It is appreciated that electrochemical anodization can be carried out in an applied anodization DC voltage range of 10-240 V with an NH₄F concentration varying in a range of 0.1-2 wt %. In another embodiment, water (H₂O 10%) can be added to the electrolyte to increase the growth rate of TiO₂ NT arrays 22.

Diameters D of TiO₂ NT arrays 22 may range from 20-550 nm and the heights h of TiO₂ NT arrays 22 may range from 0.5-12 μm. As explained in greater detail below, the emission density and the field enhancement factor of TiO₂ NT cathode 20, which can serve as a viable field emission electron source capable of generating x-ray emission, are influenced by certain parameters of TiO₂ NT arrays 22, such as diameter D and height h. The diameters D of TiO₂ NT arrays 22 can be varied by adjusting the applied electrochemical anodization DC voltage and the heights h of TiO₂ NT arrays 22 can be varied based on the electrochemical growth time.

In one embodiment, the as-grown amorphous 80 nm TiO₂ NT arrays 22 are annealed at 500° C. in ambient atmosphere for one hour, which converts TiO₂ NT arrays 22 to anatase crystal phase Annealed 5×5 mm² sized samples of 80 nm diameter TiO₂ NT arrays 22 are then bonded to an aluminum backplane with silver-based electron microscopy adhesion solution. It is appreciated that the temperature of the annealing process may vary from 500-800° C. The annealing process is typically performed immediately after the TiO₂ NT arrays 22 are grown from substrate 24 by electrochemical oxidation so that the grown TiO₂ NT arrays 22 still contain residual electrolyte. In another embodiment, previously grown samples of TiO₂ NT arrays 22 are soaked in NH₄F aqueous solution before annealing.

In one embodiment, anode 30 is a 2 mm diameter copper rod; grid electrode 40 is a weave of 30 μm diameter copper wire mesh; and detector 50 is a Varian PaxScan 4030CB CsI charge integrating detector. Anode 30 comprising a 2 mm diameter copper rod can be situated 10 mm in front of grid electrode 40 comprising a 30 μm diameter copper wire mesh. Anode 30 may also comprise a cylindrical tungsten rod. In one embodiment, a 400 μm glass spacer is placed between TiO₂ NT cathode 20 and grid electrode 40 where a 0.33 cm² area of TiO₂ NT arrays 22 is exposed to grid electrode 40. X-ray generation system 10 may also comprise a stainless steel vacuum chamber 60 with alumina electrical feedthroughs 70. In one embodiment, a borosilicate glass window 80 is placed at a right angle to anode 30 and TiO₂ NT cathode 20 to allow x-ray emission 28 to exit chamber 60, where the distance between the source and imaged object is 75 cm.

In operation of x-ray generation system 10, TiO₂ NT arrays 22 of TiO₂ NT cathode 20 are capable of emitting field emitted electrons 26, which are used to produce x-ray emission 28; thus demonstrating the viability of TiO₂ NT arrays 22 as a cold cathode. In one embodiment, x-ray generation system 10 is held at a dynamic vacuum of 5×10⁻⁷ Ton in stainless steel vacuum chamber 60 and system 10 generates x-ray emission 28 by applying a field emission current 42 of 450 μA (corresponding to a current density of 3.6 mA/cm²). In operation, the applied field emission current 42 to grid electrode 40 pulls electrons 26 out of TiO₂ NT cathode 20. Electrons 26 then pass through the copper wire mesh holes of grid electrode 40 and strike anode 30. In one embodiment, a 60 kV voltage 32 is applied to anode 30, which accelerates electrons 26 to produce x-ray emission 28.

FIG. 3(a) illustrates a radiograph image of a standard 1 mm Pb thick resolution phantom, which is produced from x-ray generation system 10 comprising a TiO₂ NT cathode 20 source. For comparison, FIG. 3(b) illustrates an image produced by a conventional medical x-ray tube (Dynamax 79-45/120, Machlett Laboratories) with a 1.2 mm focal spot, which produced a reference image with a comparable level of flux. According to one embodiment of x-ray generation system 10, FIG. 3(a) is produced with an integration time of 1 second, where, as illustrated in FIG. 1, a resolution phantom 52 is positioned at the face of detector 50. It is appreciated that while both x-ray sources provide images, as illustrated in FIGS. 3(a)-(b), of approximately 3.1 lp/mm resolution (as limited by the pixel pitch of the detector and not by the focal spot of the source), the image obtained by TiO₂ NT cathode 20 source (FIG. 3(a)) has slightly better resolution compared to the image obtained by a conventional source (FIG. 3(b)).

TiO₂ arrays 22 as field emitters can be used not only in x-ray tubes, but also in other devices, such as solar cells, flat panels, microwave generators, etc.

As explained in greater detail below, certain parameters of TiO₂ NT arrays 22, such as TiO₂ NT diameter D and TiO₂ NT height h, tend to influence the emission density and the field enhancement factor of TiO₂ NT cathode 20. It first should be noted that diameters D of TiO₂ NT arrays 22 can be varied by adjusting the applied electrochemical anodization DC voltage and the heights h of TiO₂ NT arrays 22 can be varied based on the electrochemical growth time.

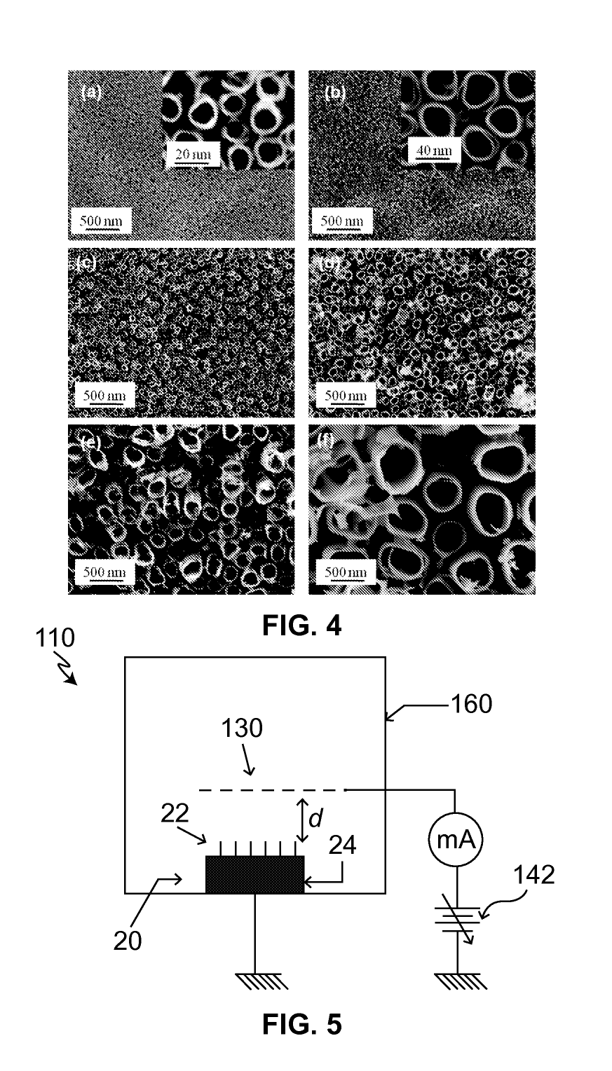

FIGS. 4(a)-(f) illustrate scanning electron microscope (SEM) images of TiO₂ NT arrays 22 with varying average NT diameters D. According to the illustrations in FIGS. 4(a)-(f), the measurement of the diameters D of TiO₂ NT arrays 22 are determined by averaging approximately twenty TiO₂ NTs in any particular sample. FIG. 4(a) depicts an SEM image of TiO₂ NT arrays 22 having diameters D of 20 nm, which are grown on a Ti sheet substrate 24 in a glycerol +0.5% NHF₄ electrolyte with an anodization DC voltage of 10 V; FIG. 4(b) depicts an SEM image of TiO₂ NT arrays 22 having diameters D of 40 nm, which are grown on a Ti sheet substrate 24 in a glycerol +0.5% NHF₄ electrolyte with an anodization DC voltage of 15 V; FIG. 4(c) depicts an SEM image of TiO₂ NT arrays 22 having diameters D of 80 nm, which are grown on a Ti sheet substrate 24 in a glycerol +0.5% NHF₄ electrolyte with an anodization DC voltage of 30 V; FIG. 4(d) depicts an SEM image of TiO₂ NT arrays 22 having diameters D of 170 nm, which are grown on a Ti sheet substrate 24 in a glycerol +0.5% NHF₄ electrolyte with an anodization DC voltage of 60 V; FIG. 4(e) depicts an SEM image of TiO₂ NT arrays 22 having diameters D of 320 nm, which are grown on a Ti sheet substrate 24 in a glycerol +0.5% NHF₄ electrolyte with an anodization DC voltage of 120 V; and FIG. 4(f) depicts an SEM image of TiO₂ NT arrays 22 having diameters D of 550 nm, which are grown on a Ti sheet substrate 24 in a glycerol +0.5% NHF₄ electrolyte with an anodization DC voltage of 240 V. As illustrated in FIGS. 4(a)-(f), TiO₂ NT cathode 20 comprises a well-defined and highly aligned tubular structure of TiO₂ NT arrays 22.

In another embodiment, TiO₂ NT arrays 22 can be grown on substrate 24 using a multi-stage growth method whereby the applied anodization DC voltage can be ramped up to 240 V in 50 V increments, where a 10 minute time interval is applied between subsequent voltage values.

The heights h of TiO₂ NT arrays 22 may also be varied during electrochemical growth. Specifically, the heights h of TiO₂ NT arrays 22 can vary based on the electrochemical growth time for a particular anodization voltage. It is expected that the growth rate of the heights h of TiO₂ NT arrays 22 in used experimental conditions should be about 100 nm per hour; however, the dependence between TiO₂ NT arrays 22 height h and growth time is not linear due to etching effects. Thus, TiO₂ NT arrays 22 height h should be confirmed experimentally from microscopic analysis. It is expected that the growth time in experimental conditions can range from 6 to 72 hours to obtain TiO₂ NT arrays 22 with heights h in the range of 0.5-12 μm.

A principle purpose of the embodiments described herein is the use of TiO₂ NT arrays 22 in TiO₂ NT cathode 20 as a viable and suitable field emission electron source capable of generating x-ray emission 28. Where certain parameters of TiO₂ NT arrays 22, such as TiO₂ NT diameter D and TiO₂ NT height h, tend to influence the emission density and the field enhancement factor of TiO₂ NT cathode 20, it is important to illustrate the understanding the behavior of the field emission of TiO₂ NT arrays 22 with geometrical parameters to improve the field emitter performance of TiO₂ NT cathode 20 (by improving the emission current density and field enhancement factor).

FIG. 5 illustrates a schematic diagram of experimental setup 110. In operation, experimental setup 110 is capable of measuring the field emission properties of TiO₂ NT cathode 20 with different parameters of TiO₂ NT arrays 22. As illustrated in FIG. 5, experimental setup 110 comprises an anode 130, a vacuum chamber 160, and TiO₂ NT cathode 20 with TiO₂ NT arrays 22 electrochemically grown on substrate 24.

To study the dependence of field emission measurements on the diameters D of TiO₂ NT arrays 22, samples of TiO₂ NT arrays 22 with average diameters D of 20 nm, 40 nm, 80 nm, 170 nm, 320 nm, and 550 nm were grown via electrochemical oxidation on Ti substrate sheets 24 in a glycerol +0.5% NHF₄ electrolyte by varying the anodizatoin voltage, as explained above and as illustrated in FIGS. 4(a)-(f). The as-grown amorphous TiO₂ NT arrays 22 were then annealed at 500° C. in air for one hour to convert TiO₂ NT arrays 22 to crystal phase. Annealed 5×5 mm² sized samples of TiO₂ NT arrays 22 with varying diameters D, according to the samples depicted in FIGS. 4(a)-(f), were then bonded to an aluminum backplane with silver paste.

In one embodiment, field emission measurements of TiO₂ NT cathode 20 are performed in vacuum chamber 160 with a base pressure of 6.6×10⁻⁵ Pa, which can be pumped down by an ion pump. A 150 μm thick glass plate (not shown) can be used to create a spacing d between TiO₂ NT cathode 20 and anode 130, where spacing d refers to the distance between the top of TiO₂ NT arrays 22 and anode 130. In the present embodiment, anode 130 is copper grid with a 30 μm diameter wire and 70% open area to be used. In operation, an applied voltage 142 can be in the range of 0-1 kV that corresponds to an electric field range of 0-6.6 V/μm. It is appreciated that the current measurements of TiO₂ NT cathode 20 can be performed by any standard current measurement systems. By way of example, the current measurement of experimental setup 110 can be performed by a Fluke 187 multimeter.

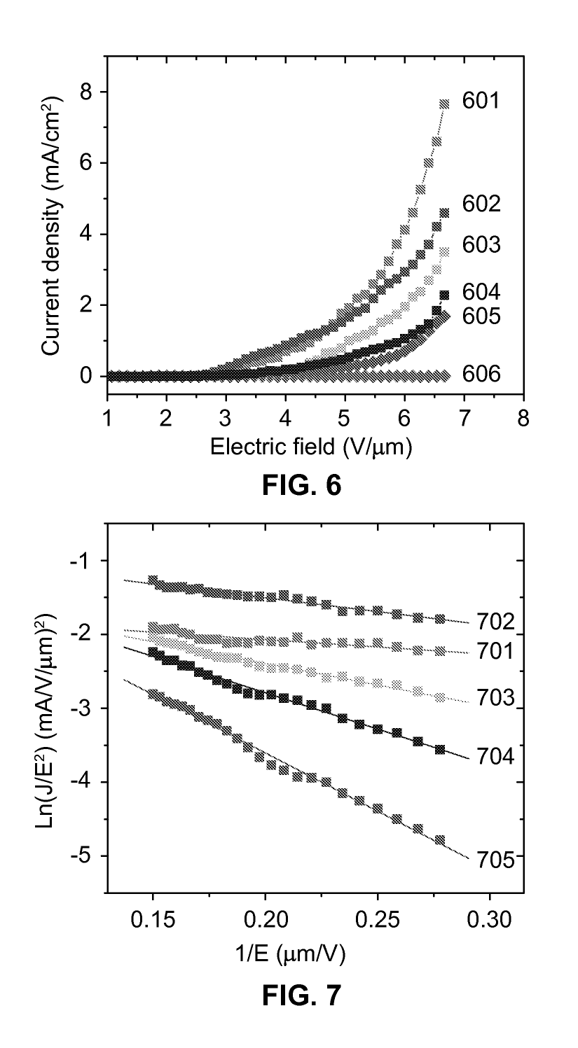

FIG. 6 illustrates current-voltage (I-V) characteristics for TiO₂ NT arrays 22 with varying diameters D, according to the sample embodiments of FIGS. 4(a)-(f). Specifically, I-V characteristics are illustrated in FIG. 6 for TiO₂ NT arrays 22 having the following NT diameters D: 320 nm (601); 550 nm (602); 170 nm (603); 80 nm (604); 40 nm (605); and 20 nm (606), which correspond to the sample embodiments of FIGS. 4(a)-(f). In the present experiment setup 110 of taking the I-V measurements of the TiO₂ NT arrays 22 of FIGS. 4(a)-(f), the heights h of TiO₂ NT arrays 22 were kept constant at ˜2 μm. As illustrated in FIG. 6, the I-V characteristics of TiO₂ NT arrays 22 with varying diameters D (601-605) exhibit exponential dependence. The analysis of the I-V characteristics of TiO₂ NT arrays 22 with varying diameters D can be accomplished using the following simplified Fowler-Nordheim (F-N) equation:

$$\begin{matrix}J = A ( \frac{{β}^{2} {E}^{2}}{φ} ) exp ( \frac{- B {φ}^{3 / 2}}{β E} ) & ( 1 ) \\ ln ( \frac{J}{{E}^{2}} ) = A ln ( \frac{{β}^{2}}{φ} ) - ( \frac{- B {φ}^{3 / 2}}{β} ) \frac{1}{E} & ( 2 )\end{matrix}$$

where A and B are constants with values 1.56×10⁻⁶ A/V² and 6.83×10³ V eV^{-3/2} μm⁻¹, respectively. Moreover, E, β, and φ refer to the electric field, field enhancement factor, and work function of TiO₂ NT arrays 22, respectively.

FIG. 7 illustrates the corresponding F-N plot of TiO₂ NT arrays 22 with diameters D of 320 nm (701); 550 nm (702); 170 nm (703); 80 nm (704); and 40 nm (705). As illustrated in FIG. 7, the nearly-linear relationships between ln(J/E²) and 1/E of F-N plots 701-705 indicate the field emission nature of TiO₂ NT cathode 20. It should be noted that the F-N plots of FIG. 7 are shown for the high electric field region of the I-V characteristic, >3 V/μm, where effective electron field emission starts. Field emission is the extraction of electrons from a solid by tunneling through the triangular shape surface potential barrier when the width of the barrier is comparable to the electron wavelength. This tunneling is possible in strong electric fields, which can be achieved in the top of the TiO₂ NT arrays 22. The local electric field E is greater than the macroscopic field V/d, where d is the distance between anode and cathode, by the field enhancement factor β. The field enhancement factor can be determined from the slope of the FN plots of FIG. 7, assuming the work function, φ, of anatase TiO₂ was taken to be 4.2 eV.

The threshold voltage of the TiO₂ NT arrays 22 with varying diameters D, according to the sample embodiments of FIGS. 4(a)-(f), can be estimated as the J=0 intercept value of the extrapolation of the high current I-V characteristics performed on the linear scale. As illustrated in FIG. 6, it is expected that the threshold voltages of the TiO₂ NT arrays 22 with varying diameters D will vary from sample to sample (601-605) within the range 2.0-5.0 V/μm. No field emission was observed for the TiO₂ NT arrays 22 sample with a diameter of 20 nm (606) within the studied electric field range (0-6.6 V/μm), which can be explained by too low electric field enhancement due to the large electric field screening effect.

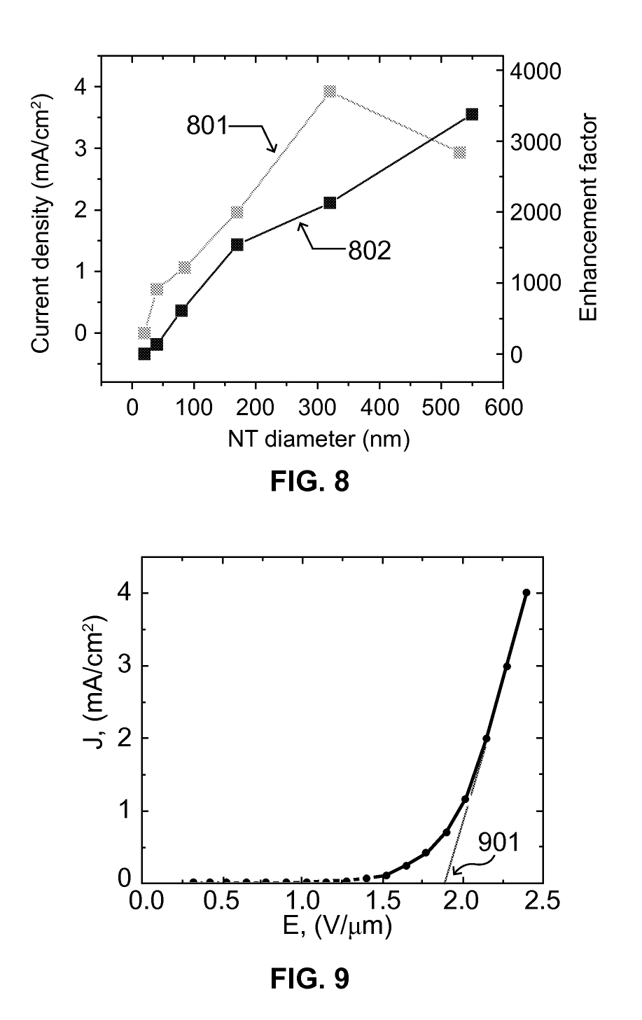

FIG. 8 illustrates a summarized plot of the field emission current density 801 and a plot of the field enhancement factor 802 for all samples of TiO₂ NT arrays 22 with varying diameters D, according to the sample embodiments of FIGS. 4(a)-(f). The measurements of FIG. 8 corresponded to an electric field of 6 V/μm, where the heights h of the TiO₂ NT arrays 22 were kept constant at ˜2 μm. As illustrated in FIG. 8, the field enhancement factor plot 802 linearly increased from ˜144 to ˜3495 as the diameters D of TiO₂ NT arrays 22 increased from 40 to 550 nm. Because no reasonable current was observed for the 20 nm diameter D sample (FIG. 4(a)) of TiO₂ NT arrays 22 within the studied electric field range, the corresponding FN plot is not shown in FIG. 8. On the other hand, the current density plot 801 first increased from 0 to ˜3.8 mA/cm² when the diameters D of TiO₂ NT arrays 22 increased from 20 to 320 nm, but then decreased with further increase in diameters D of TiO₂ NT arrays 22. Small diameter NTs are relatively dense, which increases the screening effects. The latter, in turn, reduce the field enhancement factor, which causes a reduction in current density. The opposite is true for larger diameter TiO₂ NT arrays 22, where a larger open area of NTs leads to reduced screening effects. The induced charges on top of TiO₂ NT arrays 22 are increased with diameters D, resulting in a larger field enhancement factor. The tradeoff between these two factors results in a peak position in the current density-diameter dependence when TiO₂ NT arrays 22 have diameters D of 320 nm.

In another embodiment, field emission measurements were explored for TiO₂ NT cathode 20 comprising TiO₂ NT arrays 22 with diameters D of 100 nm, where 100 nm TiO₂ NT arrays 22 were grown via electrochemical oxidation on Ti sheet substrate 24 in a glycerol+HF electrolyte using anodization voltage of 40 V. In the present embodiment, the as-grown 100 nm TiO₂ NT arrays 22 are then annealed at 500° C. in ambient atmosphere for one hour. Then, a sample 5×5 mm² sized 100 nm TiO₂ NT arrays 22 is bound to an aluminum backplate with silver paste. The field emission measurements, according to present embodiment, were then performed in a vacuum chamber 160 with a base pressure of 6.6×10⁻⁵ Pa having anode 140 with an applied voltage 142 range of 0-1 kV.

FIG. 9 illustrates current-voltage (I-V) characteristics of the 100 nm TiO₂ NT arrays 22. Evaluation of the field emission measurements of the present embodiment of TiO₂ NT cathode 20 can be done using the following simplified Fowler-Nordheim (F-N) equation:

$$J = A ( \frac{{β}^{2} {E}^{2}}{φ} ) exp ( \frac{- B {φ}^{3 / 2}}{β E} ) \qquad ( 3 )$$

where A and B are constants with values 1.56×10⁻⁶ A/V² and 6.83×10³ V eV^{-3/2} μm⁻¹, respectively. Moreover, E, β, and φ refer to the electric field, field enhancement factor, and work function of the TiO₂ NT arrays 22.

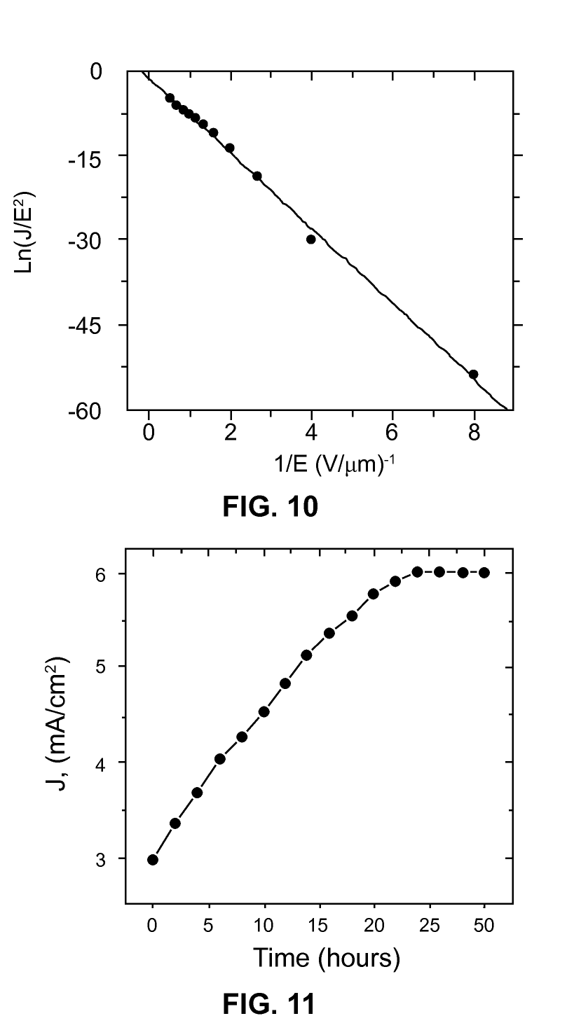

FIG. 10 illustrates the corresponding F-N plot where the linear relationship between ln(J/E²) and 1/E shows the field emission nature of TiO₂ NT cathode 20 having 100 nm TiO₂ NT arrays 22. As derived from the slope of the F-N plot illustrated in FIG. 10, the field enhancement factor is 8363 (assuming the work function of TiO₂ NT arrays 22 is 4.2 eV). As illustrated in FIG. 9, the threshold voltage 901 of the current embodiment of TiO₂ NT cathode 20 with TiO₂ NT arrays 22 of 100 nm in diameter D has a value of ˜1.8 V/μm, which can be estimated as the J=0 intercept value of the extrapolation of the high current I-V characteristics performed on the linear scale.

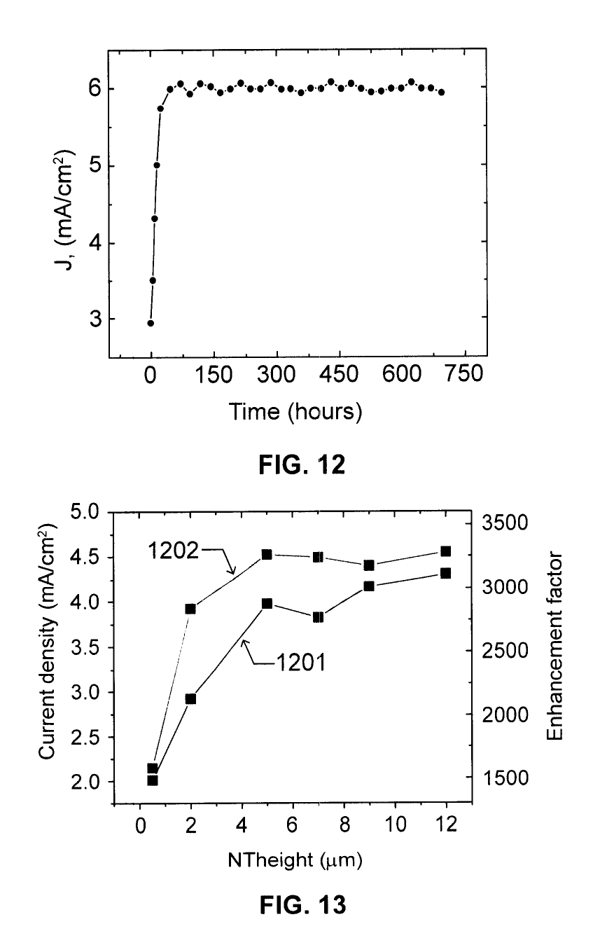

FIG. 11 illustrates a graph of the emission current stability of the present embodiment of TiO₂ NT cathode 20 (having 100 nm diameter D TiO₂ NT arrays 22) as a function of time. The emission stability can be studied by continuously recording the current at 900 V over a long period of time. As illustrated in FIG. 11, the current density at the beginning of the experiment is ˜3 mA/cm². As illustrated, the current density increases with time and reaches ˜6 mA/cm² after approximately 24 hours. FIG. 12 illustrates a similar graph of the emission current stability of the present embodiment of TiO₂ NT cathode 20 (having 100 nm diameter D TiO₂ NT arrays 22) on a larger time scale. As illustrated in the graph of FIG. 12, the current stabilizes after approximately 24 hours without much sign of degradation for more than 720 hours (30 days) with a current stability remaining within approximately 6%. Therefore, according to the measurements illustrated in FIGS. 11-12, the present embodiment of TiO₂ NT cathode 20 with 100 nm TiO₂ NT arrays 22 can be expected to have a lifetime that is substantially longer than 720 hours. It is expected that other embodiments of TiO₂ NT cathode 20 with varying diameters D also experience similarly long lifetimes. The increase in the field emission current at the beginning 24 hours, as illustrated in FIG. 11, can be explained by degassing previously absorbed molecules and subsequently improving the surface quality of TiO₂ NT arrays 22.

The field emission density and the field enhancement factor of TiO₂ NT cathode 20 is also affected by the change in the heights h of TiO₂ NT arrays 22. FIG. 13 illustrates a summarized plot of the field emission density 1201 and a plot of the field enhancement factor 1202 as a function of the heights h of TiO₂ NT arrays 22. The measurements illustrated in FIG. 13 were taken on TiO₂ NT arrays 22 having constant diameters D at ˜320 nm.

As seen from the graph of FIG. 13, the enhancement factor plot 1202 first increases with the height h and reaches the largest value of ˜3112 at h=5 μm, and then remains almost unchanged with further increase of height h, resembling saturation. The corresponding current density plot 1201 also changes in a similar way where the current density plot 1201 increases when TiO₂ NT arrays 22 height h increases from 0.5 to 5 μm, and then becoming independent with further increase of NT height h. It is appreciated that the initial increase of field enhancement factor plot 1202 and current density plot 1201, as the heights h of TiO₂ NT arrays 22 increase, can likely be explained by screening of the electric field. At the beginning, as the TiO₂ NT arrays 22 height h grows, the field enhancement plot 1202 increases as it is proportional to the TiO₂ NT arrays 22 height h; however, at some point it becomes insensitive to the NT height because of electric field screening. This saturation effect of field emission properties possibly occurs because the TiO₂ NT arrays 22 are normally interconnected at the bottom of the TiO₂ NT arrays 22.

As illustrated in FIGS. 6-13, the field emission properties of TiO₂ NT cathode 20 is effected by the parameters of TiO₂ NT arrays 22, such as diameter D and height h.

Another benefit of the embodiments provided herein is to illustrate a theoretical understanding of the behavior of the field emission of TiO₂ NT arrays 22 with optimized geometrical parameters to improve the field emitter performance of TiO₂ NT cathode 20 (by improving the emission current density and field enhancement factor). Theoretically, it is expected that the behavior of the field emission of TiO₂ NT arrays 22 as a function of the geometrical parameters can be calculated by solving Laplace equation, as further explained below. The parameters of electrochemically grown TiO2 NT arrays 22 can be controlled with high precision by varying growth conditions (anodization voltage, electrolyte composition, and growth time). It is also expected that the intertube spacing s, as illustrated in FIG. 2, of TiO₂ NT arrays 22 can also be controlled to some extent by using diethylene glycol in electrolyte during electrochemical growth. The parameters of TiO₂ NT arrays 22 can be further adjusted by wet/dry etching, doping, and plasma/thermal annealing.

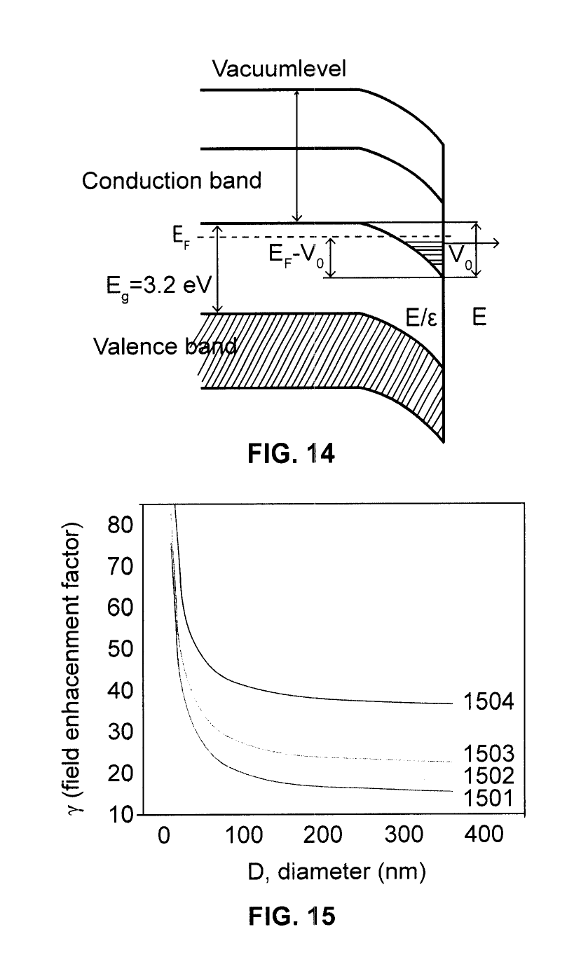

FIG. 14 illustrates an energy band diagram for a TiO₂ semiconductor in electric field. Since the Fermi level E_{F} must remain constant throughout the semiconductor, the bottom of the conduction band dips below E_{F}, leading to a pool of electrons. At high enough electric fields, this pool degenerates with the highest filled level coinciding with the Fermi level E_{F}. Thus, the effective work function Ψ of the conduction band electrons is decreased to: Ψ=χ−(E_{F}−V₀), where χ, E_{F}, and V₀, as illustrated in FIG. 14, are Fermi energy, electron affinity, and band bending, respectively.

Theoretically, the Fowler-Nordheim (F-N) formula for electron emission density of a TiO₂ semiconductor in electric field can be derived by using the following conventional field emission theory for semiconductors:

$$J = {\frac{{e}^{3}}{8 π h} [ \frac{{( γ E )}^{2}}{( χ - {vE}^{4 / 5} ) {t}^{2} ( y )} ]}^{1 / 2} \times exp \{ \frac{- 4 {\sqrt{2 m} [ χ - {v ( γ E )}^{4 / 5} ]}^{3 / 2}}{γ E} υ ( y ) \} e \qquad ( 4 )$$

where E, γ, e, and m refer to electric field, field enhancement factor, electron charge, and electron mass, respectively. Also, t² (y) is equal to 1.1; υ(y)=0.95−y², where y=((∈−1/∈+1)^{1/2}(\sqrt{e^{3E}}/χ−vE^{4/5}), v=4.5×10⁻⁷∈^{-2/5}, and ∈ is dielectric constant. The corresponding values of electron affinity x, band gap E_{g}, and dielectric constant ∈ of a TiO₂ semiconductor are 4.2 eV, 3.2 eV, and 15, respectively. Normally, the conductivity of undoped TiO₂ crystals is n-type, presumably resulting from oxygen vacancies. As illustrated in FIG. 2, a typical set of TiO₂ NT arrays 22 has heights h, diameter D, wall thickness w, and intertube spacing s.

The theoretical behavior of the field emission of TiO₂ NT arrays 22 as a function of the geometrical parameters can be calculated by solving Laplace equation. It is expected that the theoretical calculation of the field enhancement factor γ for open TiO₂ NT arrays 22 can be found to be as follows:

$$γ = \frac{0.65}{D} + \frac{0.14 h}{w} + 7 \qquad ( 5 )$$

where h, D, and w are the heights, diameter and wall thickness of TiO₂ NT arrays 22, as illustrated in FIG. 2.

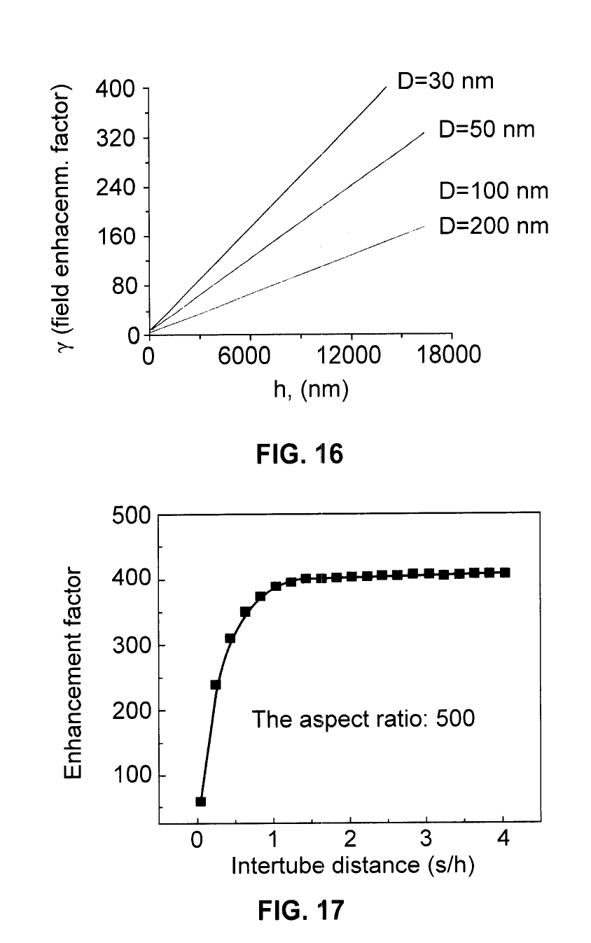

FIGS. 15-16 illustrate the effects of diameters D, heights h, and wall thickness w of an isolated TiO₂ NT on the field enhancement factor computed using equation (5) above. As illustrated in FIG. 15, it is expected that the field enhancement factor decreases rapidly when diameter D increases. The relative change of the field enhancement factor is dependent on the wall thickness w of the TiO₂ NT, whereby the smaller the wall thickness w is, the lower the relative change in the field enhancement factor is. For example, as illustrated in FIG. 15, the field enhancement factor curve 1502 of a TiO₂ NT with a 15 nm wall thickness w shows a relative change in the field enhancement factor of 60 when the diameter D increases from 10 to 200 nm; while the field enhancement factor curve 1504 of a TiO₂ NT with a 5 nm wall thickness w shows a relative change in the field enhancement factor of only 40 when the diameter D increases from 10 to 200 nm. This is explained by the reduction in electric field screening effects for larger diameter D and thinner wall thickness w TiO₂ NTs.

As illustrated in FIG. 16, it is expected that the field enhancement factor linearly increases as the height h of the TiO₂ NTs increases. Also, the rate of the field enhancement factor increase grows as the diameter D of the TiO₂ NTs increases.

FIG. 17 illustrates the dependence of the field enhancement factor on intertube spacing s. As illustrated, the field enhancement factor first increases as spacing s increases; then the field enhancement factor reaches the largest value when the spacing s is approximately equal to the height h; and then the field enhancement factor remains unchanged with further increase of spacing s, resembling saturation. Thus, it is theoretically expected that the field enhancement factor of TiO₂ NT arrays 22 is maximum when its intertube distance s is equal to the height h. This effect can be explained by screening the electric field. The bigger the intertube spacing s is, the weaker the screening of the electric field of the TiO₂ NT arrays 22 will be. At greater spacing, the induced charges on top of TiO₂ NT arrays 22 are significantly increased resulting in further increasing the field enhancement factor.

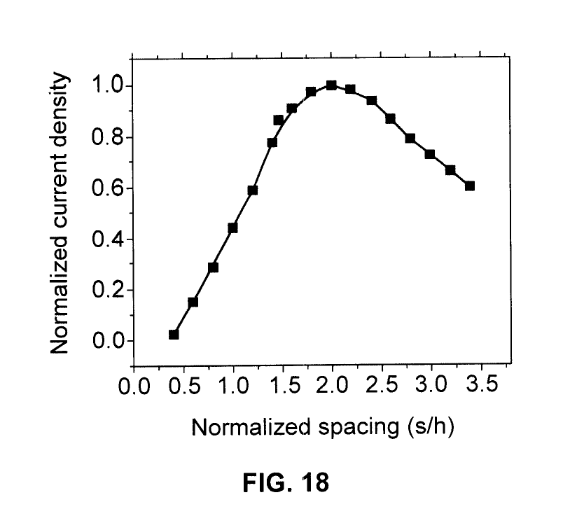

It is also theoretically expected that the dependence of the field emission current of TiO₂ NT arrays 22 will be a little different from the field enhancement factor. FIG. 18 illustrates a plot of the normalized current density of TiO₂ NT arrays 22 as a function of intertube spacing s. As illustrated, the current density first increases as the spacing s increases and the current density reaches a maximum when the spacing s equals twice the height h; however, with further increase in the spacing s, the current density starts to decrease. When the spacing s of TiO₂ NT arrays 22 is low, the large screening effect prevents the TiO₂ NT arrays 22 from an increase of the field enhancement factor; however, the corresponding current density is also small. The opposite is true for larger spacing s, which leads to reduced screening effects. However, the number of emitting sources also decreases, resulting in reduced emission current density. The trade off between these two factors results in a theoretical peak position when the spacing s is twice as large as the height h of TiO₂ NT arrays 22.

While the embodiments described herein are susceptible to various modifications and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of the appended claims.

What is claimed is:

1. A device for the generation of x-rays, comprising:
a cathode having a conductive bottom substrate acting as an electrical contact and a plurality of titanium dioxide nanotubes in electrical contact with the substrate;
a grid electrode; and
an anode.

2. The device of claim 1 further comprising a detector.

3. The device of claim 1 wherein the substrate comprises a sheet of titanium.

4. The device of claim 1 wherein the plurality of titanium dioxide nanotubes have an average diameter ranging from 20-550 nanometers.

5. The device of claim 1 wherein the plurality of titanium dioxide nanotubes have an average height ranging from 0.5-12 micrometers.

6. The device of claim 1 wherein the plurality of titanium dioxide nanotubes comprise anatase crystal phase titanium dioxide nanotubes.

7. The device of claim 1 wherein the grid electrode comprises a weave of copper wire mesh.

8. The device of claim 1 wherein the anode comprises a cylindrical copper rod.

9. The device of claim 1 wherein the anode comprises a cylindrical tungsten rod.

10. The device of claim 1 wherein the device for the generation of x-rays is held in a vacuum chamber.

11. The device of claim 1 wherein a field emission density of the cathode being tunable as a function of average height and average diameter of the titanium dioxide nanotubes.

12. The device of claim 1 wherein a field enhancement factor of the cathode being tunable as a function of average height and average diameter of the titanium dioxide nanotubes.

13. The device of claim 1 wherein the device is configured to produce a radiograph image.
